(19) United States
(12) Patent Application Publication
(10) Pub. No.: US 2017/0171495 A1
(43) Pub. Date: Jun. 15, 2017

(54) Method and Electronic Device for Displaying Live Programme

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Bin SHI, Beijing (CN)

(21) Appl. No.: 15/239,775

(22) Filed: Aug. 17, 2016

Related U.S. Application Data
(63) Continuation of application No. PCT/CN2016/089228, filed on Jul. 7, 2016.

(30) Foreign Application Priority Data
Dec. 15, 2015 (CN) 201510938123.4

(51) Int. Cl. H04N 5/45; H04N 5/445

(52) U.S. Cl. CPC H04N 5/45; H04N 5/44591

(57) ABSTRACT

The present disclosure provide a method and device for displaying a live programme, which is applied to a terminal device. Wherein, the method includes: opening a first live window; determining a first live view of a current programme; playing an image of the first live view in the first live window; opening a second live window; determining a second live view of the current programme; and playing an image of the second live view in the second live window. In embodiments of the present disclosure, if the same live programme may provide multiple live views (e.g., one camera position is one view), in addition to opening a main window, a secondary window may also be opened within or aside the main window. A user may watch two live views at the same time and choose live views independently without interrupting watching, which improves watching efficiency and user experience as well.

### CROSS REFERENCE TO RELATED APPLICATION

The present disclosure is a continuation of International Application No. PCT/CN2016/089228, with an international filing date of Jul. 7, 2016, which claims priority to Chinese Patent Application No. 201510938123.4, entitled “METHOD AND DEVICE FOR DISPLAYING LIVE PROGRAMME, and filed with State Intellectual Property Office on Dec. 15, 2015, both of which are incorporated herein by reference in their entireties.

### TECHNICAL FIELD

The present disclosure relates to the field of communication technique, and in particular, to a method and electronic device for displaying a live programme.

### BACKGROUND

At current, it has become an essential element in our daily life to watch a live programme by a terminal device such as a TV, a cell phone etc. Users may turn on the TV or open an APP in the cell phone, and then choose a live programme they want to watch. However, in the prior art, generally the users can only watch one scene view of the current live programme. If the users want to switch a scene view, they can only close the image current played, and then choose another view, which is inconvenient.

### SUMMARY

To overcome the existing problem in the prior art, the present disclosure provides a method and electronic device for displaying a live programme, so as to improve the efficiency when user watch the same live programme.

According to a first aspect of embodiments of the present disclosure, it provides a method for displaying a live programme, including: opening a first live window; determining a first live view of a current programme; playing an image of the first live view in the first live window; opening a second live window; determining a second live view of the current programme; and playing an image of the second live view in the second live window.

According to a second aspect of the embodiments of the present disclosure, the embodiment of the present disclosure provides a non-volatile computer-readable storage medium stored with computer executable instructions, the computer executable instructions are configured to perform any one of the method for displaying a live programme described above in the disclosure.

According to a third aspect of the embodiments of the present disclosure, the embodiment of the present disclosure provides an electronic device, including: at least one processor; and a memory; wherein, the memory is communicably connected with the at least one processor for storing instructions executed by the at least one processor, the computer executable instructions are configured to perform any one of the method for adjusting video subtitles described above in the disclosure.

It should be understood that, the above general description and the detailed description hereinafter are merely exemplary and explanatory, which are not used to limit the scope of the present disclosure.

### BRIEF DESCRIPTION OF THE DRAWINGS

One or more embodiments are illustrated by way of examples, and not by limitation, in the figures of the accompanying drawings, wherein elements having the same reference numeral designations represent like elements throughout. The drawings are not to scale, unless otherwise disclosed.

FIG. 1 is a flow chart of a method for displaying a live programme according to an exemplary embodiment;

FIG. 2 is a schematic diagram of the position of a secondary window according to an exemplary embodiment;

FIG. 3 is a schematic diagram of the position of a secondary window according to an exemplary embodiment;

FIG. 4 is a flow chart of a method for displaying a live programme according to an exemplary embodiment;

FIG. 5 is a schematic diagram of alive view list according to an exemplary embodiment;

FIG. 6 is a flow chart of a method for displaying a live programme according to an exemplary embodiment;

FIG. 7 is a flow chart of a method for displaying a live programme according to an exemplary embodiment;

FIG. 8 is a flow chart of a method for displaying a live programme according to an exemplary embodiment;

FIG. 9 is a schematic diagram for choosing other programme according to an exemplary embodiment;

FIG. 10 is a schematic diagram of a device for displaying a live programme according to an exemplary embodiment;

FIG. 11 is a schematic diagram of a device for displaying a live programme according to an exemplary embodiment;

FIG. 12 is a schematic diagram of a device for displaying a live programme according to an exemplary embodiment;

FIG. 13 is a schematic diagram of a device for displaying a live programme according to an exemplary embodiment;

FIG. 14 is structure schematic diagram of an electronic device provided in the embodiments of the present disclosure.

### DETAILED DESCRIPTION

Here, exemplary embodiments are illustrated in details, examples of which are illustrated in the accompanying drawing. Where the description below relates to drawings, unless otherwise disclosed, the same reference numeral in different drawings represents the same or like element. Implementations described in exemplary embodiments below do not represent all implementations in conformity with the present disclosure. On the contrary, they are merely examples of the device and method in conformity with some aspects of the present disclosure as expatiated in the accompanying claims.

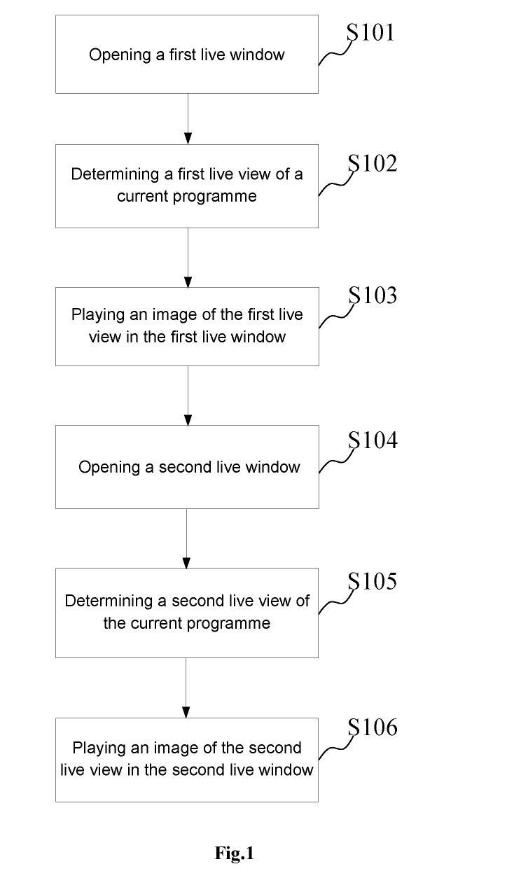

FIG. 1 is a flow chart of a method for displaying a live programme according to an exemplary embodiment. The method may be applied to a terminal device such as a cell phone, a tablet computer etc.

Referring to FIG. 1, the method may include the following steps.

In step S101: a first live window is opened.

The first live window is a main window. A user may turn on the TV or open an APP in a cell phone to open a default main window.

In step S102: a first live view of a current programme is determined.

In the present embodiment, the current live programme provides two or more live views (e.g., one camera position is one view) for selection, the user may determine which live view is the first live view, i.e., the main view by operation. The terminal device may also determine one of two or more live views as the first live view, automatically.

In step S103: an image of the first live view is played in the first live window.

In step S104: a second live window is opened.

The second live window is a secondary window. A user may make the terminal device open the secondary window by operation after the main window is opened. The terminal device may also open the secondary window automatically after opening the main window.

In step S105: a second live view of the current programme is determined.

A user may determine which live view is the second live view, i.e., the secondary view by operation. The terminal device may also determine one of two or more live views as the second live view, automatically.

In step S106: an image of the second live view is played in the second live window.

Thus, there are two windows that is the main window and the secondary window. In this way, the user can watch two live views at the same time and choose live views independently without interrupting watching, which improves watching efficiency and user experience as well.

As for the size and position of the second live window, i.e., secondary window, the present embodiment does not limit hereto. As an example, an area of the second live window may be smaller than that of the first live window, and the position thereof may be located within or aside the first live window.

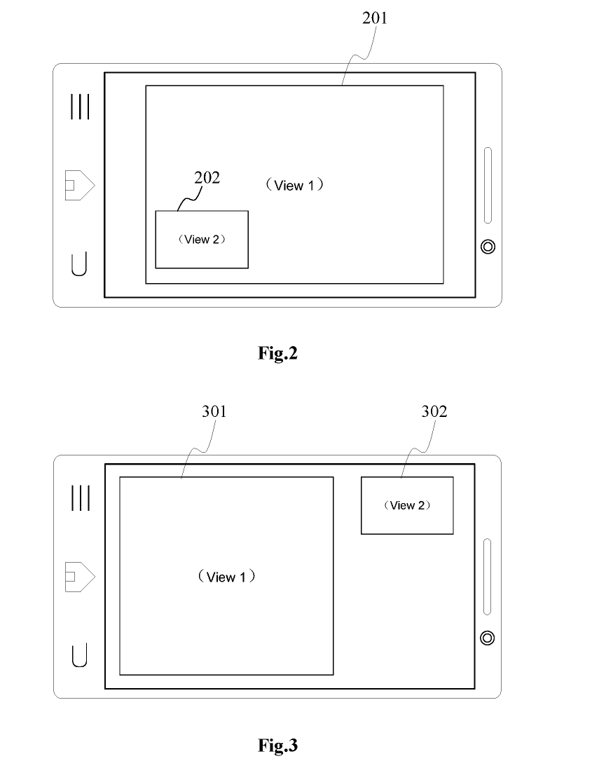

Referring to FIGS. 2 and 3, in FIG. 2, 201 is a first live window for playing the image of the view 1, and 202 is a second live window for playing the image of the view 2, wherein the second live window is located within the first live window.

In FIG. 3, 301 is a first live window and 302 is a second live window, wherein the second live window is located aside the first live window.

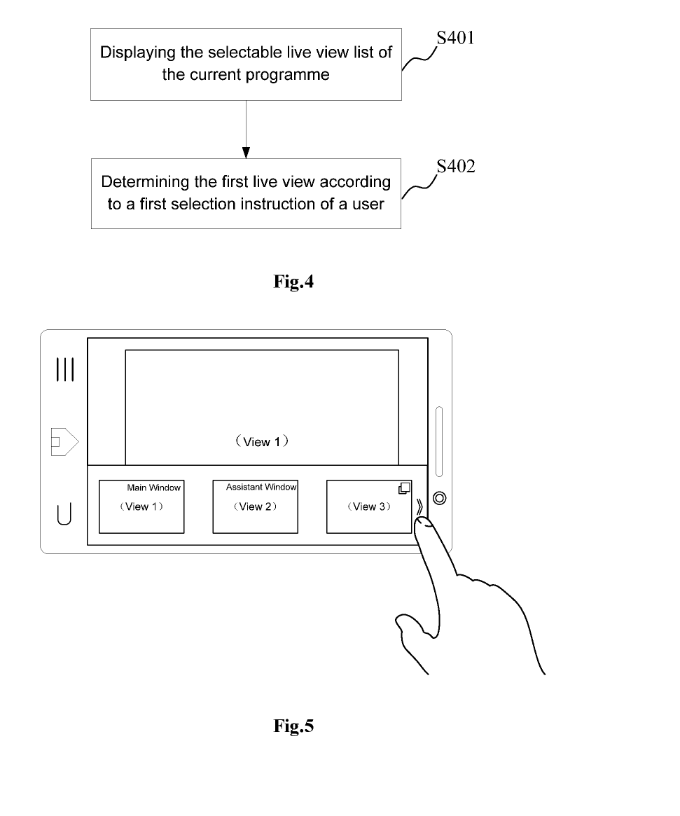

Referring to FIG. 4, in the present embodiment or some other embodiments of the present disclosure:

The determining a first live view may include the following steps.

In step S401: a selectable live view list of the current programme is displayed.

In step S402: the first live view is determined according to a first selection instruction of a user.

As an example, referring to FIG. 5, a user may open a selectable live view list of the current programme by some operation, browse the live view list by clicking a button rolling rightward in FIG. 5, and send out a selection instruction by the way of clicking to select one view in the list as the first live view.

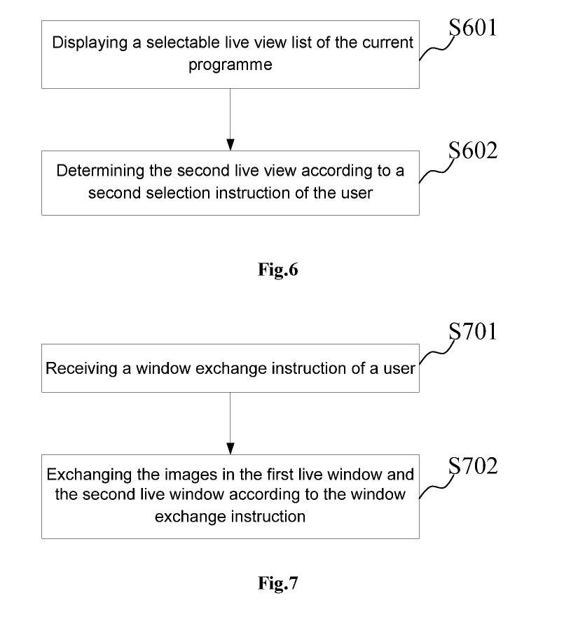

Similarly, referring to FIG. 6, the determining a first live view may include the following steps.

In step S601: the selectable live view list of the current programme is displayed.

In step S602: the second live view is determined according to a second selection instruction of the user.

Additionally, referring to FIG. 7, in the present embodiment or some other embodiments of the present disclosure, the method may further include the following steps.

In step S701: a window exchange instruction of a user is received.

In step S702: the images in the first live window and the second live window are exchanged according to the window exchange instruction.

Thus, the user may adjust contents of main and secondary windows independently so as to get a better viewing effect.

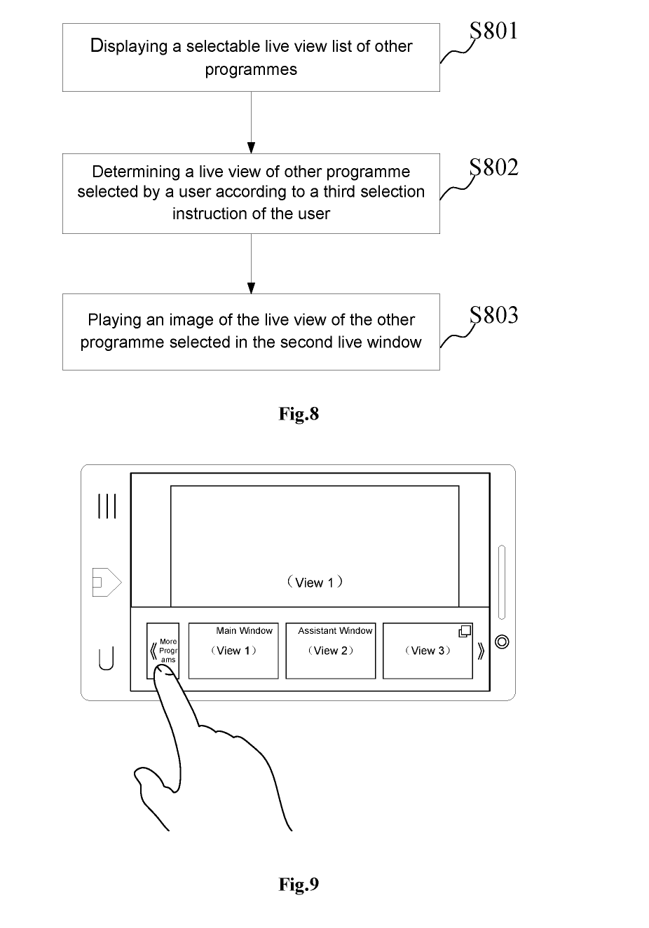

Besides, referring to FIG. 8, in the present embodiment or some other embodiments of the present disclosure, the method may further include the following steps.

In step S801: a selectable live view list of other programmes is displayed.

In step S802: a live view of other programme selected by a user is determined according to a third selection instruction of the user.

In step S803: an image of the live view of the other programme selected is played in the second live window.

This is because sometimes a user might also pay attention to other live programme while watching the current live programme. As an example, referring to FIG. 9, the button “more programmes” in the figure is equivalent to an entry of more live programmes. The user can choose a live view of another programme by clicking the button for the secondary window to play, so that the effect of being able to browse other live programme without closing the current programme, may be reached.

In the present embodiment, if the same live programme may provide multiple live views (e.g., one camera position is one view), in addition to opening a main window, a secondary window may also be opened within or aside the main window when a live programme is played on a terminal device such as a cell phone, tablet computer etc. In this way, a user may watch two live views at the same time and choose live views independently without interrupting watching, which improves watching efficiency and user experience as well.

The following is device-type embodiments of the present disclosure, which may be used to execute method-type embodiments of the present disclosure. As for details not disclosed in the device-type embodiments of the present disclosure, please refer to method-type embodiments of the present disclosure.

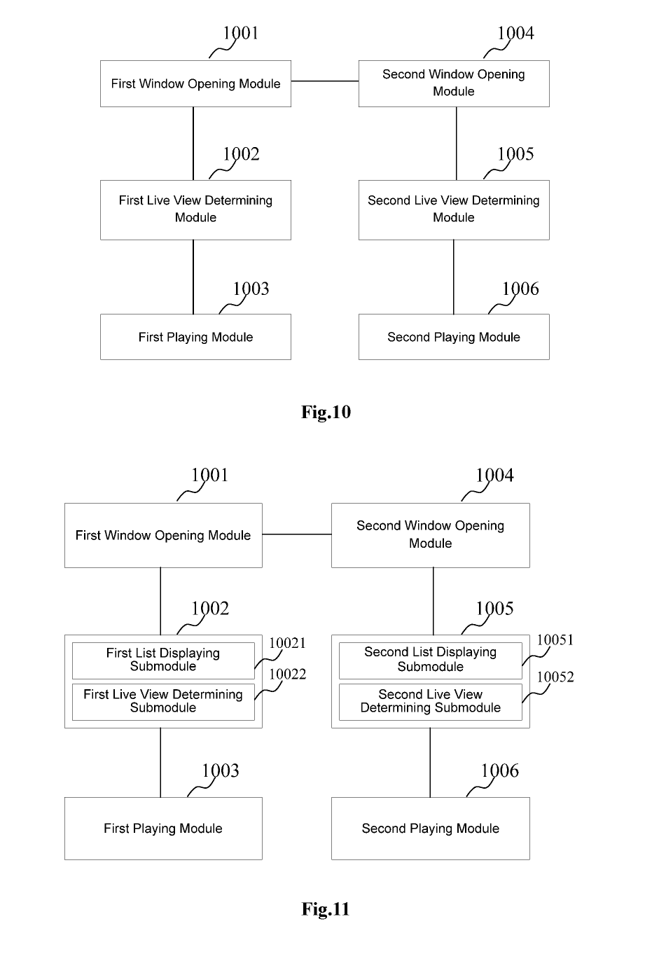

FIG. 10 is a schematic diagram of a device for displaying a live programme according to an exemplary embodiment. The device may be applied to a terminal device such as a cell phone, a tablet computer etc.

Referring to FIG. 10, the device may include: a first window opening module 1001, a first live view determining module 1002, a first playing module 1003, a second window opening module 1004, a second live view determining module 1005 and a second playing module 1006.

The first window opening module 1001 may open a first live window;

The first live view determining module 1002 may determine a first live view of a current programme;

The first playing module 1003 may play an image of the first live view in the first live window;

The second window opening module 1004 may open a second live window;

The second live view determining module 1005 may determine a second live view of the current programme;

The second playing module 1006 may play an image of the second live view in the second live window.

As for the size and position of the second live window, i.e., secondary window, the present embodiment does not limit hereto. As an example, an area thereof may be smaller than the first live window, and the position thereof may be located within or aside the first live window.

Referring to FIG. 11, in the present embodiment or some other embodiments of the present disclosure, the first live view determining module may include: a first list displaying submodule 10021 and a first live view determining submodule 10022.

The first list displaying submodule 10021 may display a selectable live view list of the current programme.

The first live view determining submodule 10022 may determine the first live view according to a first selection instruction of a user.

The second live view determining module may include: a second list displaying submodule 10051 and a second live view determining submodule 10052.

The second list displaying submodule 10051 may display the selectable live view list of the current programme; and

The second live view determining submodule 10052 may determine the second live view according to a second selection instruction of the user.

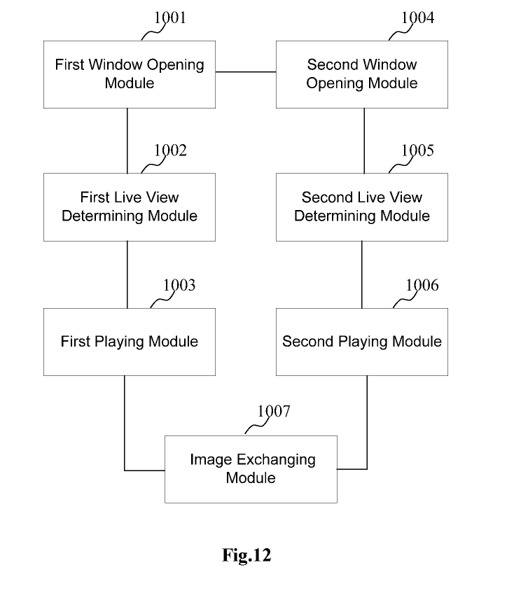

Referring to FIG. 12, in the present embodiment or some other embodiments of the present disclosure, the device may further include: an image exchanging module 1007.

The image exchanging module 1007 may receive a window exchange instruction of a user and exchange the images in the first live window and the second live window according to the window exchange instruction.

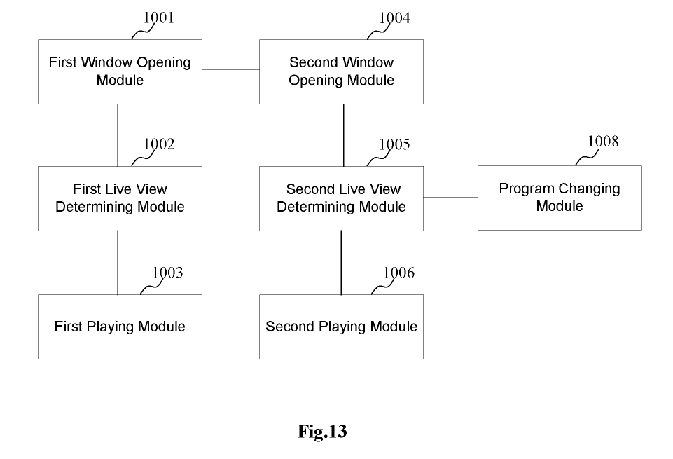

Referring to FIG. 13, in the present embodiment or some other embodiments of the present disclosure, the device may further include: a programme changing module 1008.

The programme changing module 1008 may display a selectable live view list of other programmes, determine a live view of the other programme selected by a user according to a third selection instruction of the user; and play an image of the live view of the other programme selected in the second live window.

In the present embodiment, if the same live programme may provide multiple live views (e.g., one camera position is one view), in addition to opening a main window, a secondary window may also be opened within or aside the main window when a live programme is played on a terminal device such as a cell phone, a tablet computer etc. In this way, a user may watch two live views at the same time and choose live views independently without interrupting watching, which improves watching efficiency and user experience as well.

With respect to the devices in above embodiments, the specific implementations for performing operation of each module have been described in details in the embodiments relevant to the method, and will not be illustrated here again in detail.

The embodiments of the present disclosure further provide a non-volatile computer-readable storage medium, the non-volatile computer-readable storage medium is stored with computer executable instructions which are used to perform any of the embodiments described above of the method for displaying a live programme.

FIG. 14 is a schematic diagram of hardware structure of an electronic device used to perform the method for displaying a live programme according to an embodiment of the present disclosure, as shown in FIG. 14, the device includes:

One or more processors 1410 and a memory 1420, FIG. 14 illustrates one processor 1410 as an example.

The device for the method for displaying a live programme may further include an input device 1430 and an output device 1440.

The processor 1410, the memory 1420, the input device 1430 and the output device 1440 may be connected with each other through bus or other forms of connections. FIG. 14 illustrates bus connection as an example.

As a non-volatile computer readable storage medium, the memory 1420 may be configured to store non-volatile software program, non-volatile computer executable program and modules, such as program instructions/modules corresponding to the method for displaying a live programme according to the embodiments of the disclosure (for example, each module illustrated in FIG. 10. By executing the non-volatile software program, instructions and modules stored in the memory 1420, the processor 1410 may perform various functional applications of the server and data processing, that is, the method for displaying a live programme according to the above mentioned embodiments.

The memory 1420 may include a program storage area and a data storage area, wherein, the program storage area may be stored with the operating system and applications which are needed by at least one functions, and the data storage area may be stored with data which is created according to use of the device for displaying a live programme. Further, the memory 1420 may include a high-speed random access memory, and may further include non-volatile memory, such as at least one of disk memory device, flash memory device or other types of non-volatile solid state memory device. In some embodiments, optionally, the memory 1420 may include memory provided remotely from the processor 1410, and such remote memory may be connected with the device for displaying a live programme through network connections, the examples of the network connections may include but not limited to internet, intranet, LAN (Local Area Network), mobile communication network or combinations thereof.

The input device 1430 may receive inputted number or character information, and generate key signal input related to the user settings and functional control of the device for displaying a live programme. The output device 1440 may include a display device such as a display screen.

The above one or more modules may be stored in the memory 1420, when these modules are executed by the one or more processors 1410, the method for displaying a live programme according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) Mobile communication device, characterized in having a function of mobile communication mainly aimed at providing speech and data communication, wherein such terminal includes: smart phone (such as iPhone), multimedia phone, functional phone, low end phone and the like;

(2) Ultra mobile personal computer device, which falls in a scope of personal computer, has functions of calculation and processing, and generally has characteristics of mobile internet access, wherein such terminal includes: PDA, MID and UMPC devices, such as iPad;

(3) Portable entertainment device, which can display and play multimedia contents, and includes audio or video player (such as iPod), portable game console, E-book and smart toys and portable vehicle navigation device;

(4) Server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) Other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and include several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

1. A method for displaying a live programme, comprising:
at an electronic device:
opening a first live window;
determining a first live view of a current programme;
playing an image of the first live view in the first live window;
opening a second live window;
determining a second live view of the current programme; and
playing an image of the second live view in the second live window.

2. The method according to claim 1, wherein, an area of the second live window is smaller than that of the first live window; the second live window is located within the first live window, or, located aside the first live window.

3. The method according to claim 1, wherein:
the determining a first live view comprises:
displaying the selectable live view list of the current programme; and
determining the first live view according to a first selection instruction of a user;
the determining a second live view comprises:
displaying a selectable live view list of the current programme; and
determining the second live view according to a second selection instruction of the user.

4. The method according to claim 1, further comprising:
receiving a window exchange instruction of a user; and
exchanging the images in the first live window and the second live window according to the window exchange instruction.

5. The method according to claim 1, further comprising:
displaying a selectable live view list of other programmes;
determining a live view of other programme selected by a user according to a third selection instruction of the user; and
playing an image of the live view of the other programme selected in the second live window.

6-11. (canceled)

12. A non-volatile computer-readable storage medium stored with computer executable instructions that, when executed by an electronic device, cause the electronic device to:
open a first live window;
determine a first live view of a current programme;
play an image of the first live view in the first live window;
open a second live window;
determine a second live view of the current programme; and
play an image of the second live view in the second live window.

13. The non-volatile computer-readable storage medium according to claim 12, wherein, an area of the second live window is smaller than that of the first live window; the second live window is located within the first live window, or, located aside the first live window.

14. The non-volatile computer-readable storage medium according to claim 12, wherein:
the determining a first live view comprises:
displaying the selectable live view list of the current programme; and
determining the first live view according to a first selection instruction of a user;
the determining a second live view comprises:
displaying a selectable live view list of the current programme; and
determining the second live view according to a second selection instruction of the user.

15. The non-volatile computer-readable storage medium according to claim 12, wherein, the electronic device is further caused to:
receive a window exchange instruction of a user; and
exchange the images in the first live window and the second live window according to the window exchange instruction.

16. The non-volatile computer-readable storage medium according to claim 12, wherein, the electronic device is further caused to:
display a selectable live view list of other programmes;
determine a live view of other programme selected by a user according to a third selection instruction of the user; and
play an image of the live view of the other programme selected in the second live window.

17. An electronic device, comprising:
at least one processor; and
a memory, communicably connected with the at least one processor for storing instructions executed by the at least one processor,
wherein the execution of the instructions by the at least one processor causes the at least one processor to:
open a first live window;
determine a first live view of a current programme;
play an image of the first live view in the first live window;
open a second live window;
determine a second live view of the current programme; and
play an image of the second live view in the second live window.

18. The electronic device according to claim 17, wherein, an area of the second live window is smaller than that of the first live window; the second live window is located within the first live window, or, located aside the first live window.

19. The electronic device according to claim 17, wherein:
the determining a first live view comprises:
displaying the selectable live view list of the current programme; and
determining the first live view according to a first selection instruction of a user;
the determining a second live view comprises:
displaying a selectable live view list of the current programme; and
determining the second live view according to a second selection instruction of the user.

20. The electronic device according to claim 17, wherein, the at least one processor is further caused to:
receive a window exchange instruction of a user; and
exchange the images in the first live window and the second live window according to the window exchange instruction.

21. The electronic device according to claim 17, wherein, the at least one processor is further caused to
display a selectable live view list of other programmes;
determine a live view of other programme selected by a user according to a third selection instruction of the user; and
play an image of the live view of the other programme selected in the second live window.
